(19) United States
(12) Patent Application Publication
(10) Pub. No.: US 2024/0391315 A1
(43) Pub. Date: Nov. 28, 2024

(54) OFF-ROAD VEHICLE DYNAMICS

(71) Applicant: FORD GLOBAL TECHNOLOGIES, LLC, Dearborn, MI (US)

(72) Inventors: Bang Kim CAO, Northville, MI (US); Zubair FEROZ, Dearborn, MI (US); Shubham DIXIT, Lucknow (IN); Jonathan SULLIVAN, Ferndale, MI (US); Matthew John SHELTON, Grosse Ile, MI (US)

(21) Appl. No.: 18/322,041

(22) Filed: May 23, 2023

(51) Int. Cl. B60K 23/08; B60K 1/02; B60K 17/356; B60W 10/08; B60W 10/119; B60W 10/184

(52) U.S. Cl. CPC B60K 23/0808; B60K 1/02; B60K 17/356; B60W 10/08; B60W 10/119; B60W 10/184; B60W 2520/26; B60W 2540/10; B60W 2540/18; B60W 2710/083; B60W 2710/18

(57) ABSTRACT

A vehicle includes a front axle having left and right front wheels and operably coupled to a first powerplant and a rear axle including left and right rear wheels operably coupled to one or more second powerplants. A controller is programmed to, in response to (i) a pivot-assist mode being requested and (ii) a steering wheel being turned beyond a threshold: command braking torques to one or more wheels and forward and/or reverse torques to one or more other wheels to induce moment at the front axle or rear axle.

### TECHNICAL FIELD

The present disclosure relates to off-road vehicle driving and more particularly to off-road driving modes that assist with pivoting of the vehicle about the front or rear axles.

### BACKGROUND

Vehicles such as fully electric vehicles and hybrid-electric vehicles contain a traction-battery assembly to act as an energy source for the vehicle. The traction battery may include components and systems to assist in managing vehicle performance and operations. The traction battery may also include high-voltage components, and an air or liquid thermal-management system to control the temperature of the battery. The traction battery is electrically connected to an electric machine that provides torque to driven wheels. Electric machines typically include a stator and a rotor that cooperate to convert electrical energy into mechanical motion or vice versa.

### SUMMARY

According to one embodiment, a vehicle includes a front axle having left and right front wheels and operably coupled to a first powerplant. A rear axle has left and right rear wheels operably coupled to a second powerplant. The vehicle further includes a steering wheel and at least one driver-actuatable input having at least a first state and a second state. A controller of the vehicle is programmed to, in response to (i) the vehicle being in an off-road driving mode, (ii) the input being in the first position, and (iii) the steering wheel being turned right beyond a threshold: command braking torques to the front and rear right wheels, respectively, command zero torque to the first powerplant, and command a forward torque to the second powerplant based on a driver-demanded torque.

According to another embodiment, a vehicle includes a front axle having left and right front wheels and operably coupled to a first powerplant and a rear axle including left and right rear wheels operably coupled to first and second electric machines, respectively. A controller is programmed to, in response to (i) a front pivot assist being requested and (ii) a steering wheel being turned right beyond a threshold: command a braking torque to the left front wheel, command a reverse torque to the first powerplant, command a first forward torque to first electric machine, and command a second forward torque to the second electric machine that is less than the first forward torque.

According to yet another embodiment, a vehicle includes a front axle having left and right front wheels and operably coupled to a powerplant and a rear axle having left and right rear wheels operably coupled to first and second electric machines, respectively. The vehicle further includes steering wheel, an accelerator pedal, and at least one driver-actuatable input. A controller is programmed to: in response to the accelerator pedal being depressed, the steering wheel being turned RIGHT, and the at least one driver-actuatable input being selected, command forward torques to the powerplant and the first electric machine and command a reverse torque to the second electric machine; and, in response to the accelerator pedal being depressed, the steering wheel being turned LEFT, and the at least one driver-actuatable input being selected, command forward torques to the powerplant and the second electric machine and command a reverse torque to the first electric machine.

### BRIEF DESCRIPTION OF THE DRAWINGS

FIG. 1 is a schematic diagram of an electric machine according to one embodiment.

FIG. 2 is a perspective view of a transmission gear shifter.

FIG. 3 is a schematic diagram of the vehicle of FIG. 1 showing the torque commands during a front pivot assist turn to the right.

FIG. 4 is a schematic diagram of the vehicle of FIG. 1 showing the torque commands during a rear pivot assist turn to the right.

FIG. 5 is a schematic diagram of an electric machine according to one embodiment.

FIG. 6 is a schematic diagram of the vehicle of FIG. 5 showing the torque commands during a front pivot assist turn to the right.

FIG. 7 is a schematic diagram of the vehicle of FIG. 5 showing the torque commands during a rear pivot assist turn to the right.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

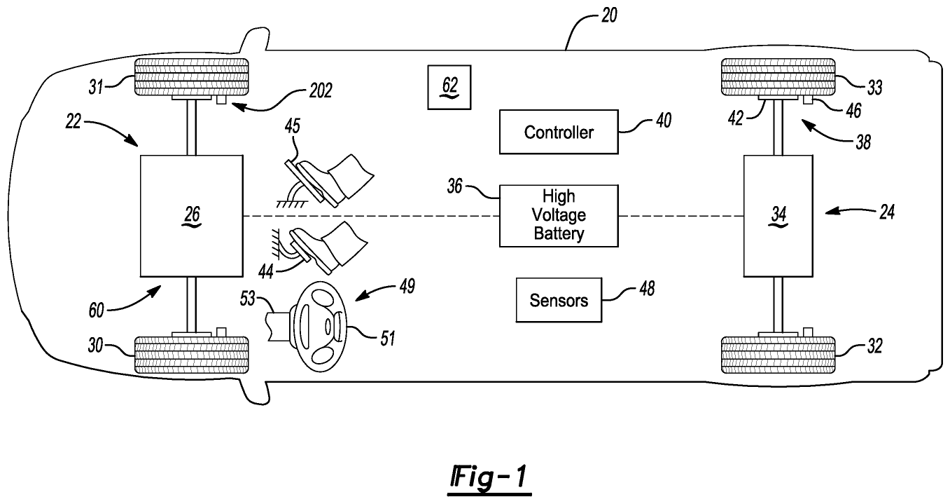

Referring to FIG. 1, a vehicle 20 is illustrated as a fully electric vehicle but, in other embodiments, the vehicle 20 may be a hybrid-electric vehicle that also includes an internal-combustion engine or a conventionally powered vehicle having a pair of engines. The vehicle 20 may have all-wheel drive (AWD). The vehicle 20 may include a primary drive axle 24 and a secondary drive axle 22. In the illustrated embodiment, the primary drive axle 24 is the rear axle and the secondary drive axle 22 is the front axle. In other embodiments, the front axle may be the primary drive and the rear axle may be the secondary drive. The primary and secondary axles may include their own powerplant, e.g., an engine and/or an electric machine, and are capable of operating independently of each other or in tandem to accelerate (propel) or brake the vehicle 20.

The secondary drive axle 22 may include at least one powerplant, e.g., electric machine 26, operable to power the wheels 30 and 31. A gearbox (not shown) may be included to change a speed ratio between the wheels 30, 31 and the powerplant(s). The gearbox may be a one-speed direct drive or a multi-speed gearbox. The primary drive axle 24 may include at least one powerplant, e.g., an electric machine 34, that is operably coupled to the wheels 32 and 33. A gearbox (not shown) may be included change a speed ratio between the powerplant(s) 34 and the wheels 32, 33. In one or more embodiments, the electric machine 26, 34 are permanent magnet synchronous alternating current (AC) motors or other suitable type.

The electric machine 26, 34 are powered by one or more traction batteries, such as traction battery 36. The traction battery 36 stores energy that can be used by the electric machine 26, 34. The traction battery 36 may provide a high-voltage direct current (DC) output from one or more battery cell arrays, sometimes referred to as battery cell stacks, within the traction battery 36. The battery cell arrays include one or more battery cells. The battery cells, such as a prismatic, pouch, cylindrical, or any other type of cell, convert stored chemical energy to electrical energy. The cells may include a housing, a positive electrode (cathode), and a negative electrode (anode). An electrolyte allows ions to move between the anode and cathode during discharge, and then return during recharge. Terminals may allow current to flow out of the cell for use by the vehicle 20. Different battery pack configurations may be available to address individual vehicle variables including packaging constraints and power requirements. The battery cells may be thermally managed with a thermal management system.

The traction battery 36 may be electrically connected to one or more power-electronics modules through one or more contactors. The module may be electrically connected to the electric machine 26, 34 and may provide the ability to bi-directionally transfer electrical energy between the traction battery 36 and the electric machine 26, 34. For example, a traction battery 36 may provide a DC voltage while the electric machine 26, 34 may require a three-phase AC voltage to function. The power-electronics module may convert the DC voltage to a three-phase AC voltage as required by the electric machines. In a regenerative mode, the power-electronics module may convert the three-phase AC voltage from the electric machine 26, 34 acting as generators to the DC voltage required by the traction battery 36.

The vehicle 20 includes a controller 40 that is in electronic communication with a plurality of vehicle systems and is configured to coordinate functionality of the vehicle. The controller 40 may be a vehicle-based computing system that includes one or more controllers that communicate via a serial bus (e.g., controller area network (CAN)) or via dedicated electrical conduits. The controller 40 generally includes any number of microprocessors, ASICs, ICs, memory (e.g., FLASH, ROM, RAM, EPROM and/or EEPROM) and software code to co-act with one another to perform a series of operations. The controller 40 also includes predetermined data, or “lookup tables” that are based on calculations and test data and are stored within the memory. The controller 40 may communicate with other vehicle systems and controllers over one or more wired or wireless vehicle connections using common bus protocols (e.g., CAN and LIN). Used herein, a reference to “a controller” refers to one or more controllers. The controller 40, in one or more embodiments, any include any of the follow control modules: a battery energy control module (BECM) that operates at least the traction battery, an engine control module (ECM) that operates at least the engine, a powertrain control module (PCM) that operates at least the electric machines, the gearboxes, and the differential(s), and an ABS control module that controls the anti-lock braking system (ABS) 38.

The ABS 38, while illustrated as a hydraulic system, may be electronic or a combination of electronic and hydraulic. The ABS 38 may include a brake module and a plurality of friction brakes 42 located at each of the wheels. Modern vehicles typically have disc brakes; however, other types of friction brakes are available, such as drum brakes. Each of the brakes 42 are in fluid communication with the brake module via a brake line configured to deliver fluid pressure from the module to a caliper of the brake 42. The module may include a plurality of valves configured to provide independent fluid pressure to each of the brakes 42. The brake module may be controlled by operation of a brake pedal 44 and/or by the vehicle controller 40 with or without input from the driver. The ABS system 38 also includes associated wheel-speed sensors 46 each located on one of the wheels. Each sensor 46 is configured to output a wheel-speed signal to the controller 40 indicative of a measured wheel speed. Wheel speed may be used by the controller to calculate wheel slip using known methods.

The vehicle 20 is configured to slow down using regenerative braking, friction braking, or a combination thereof. The controller 40 includes programming for aggregating a demanded braking torque between regenerative braking, i.e., the electric machines, and the friction brakes 42. The demanded braking torque may be based on driver input, e.g., a position of the brake pedal 44 or a hand-operated actuator, or by the controller 40. The aggregator of the controller 40 may be programmed to prioritize regenerative braking whenever possible.

The vehicle 20 includes an accelerator pedal 45. The accelerator pedal 45 includes a range of travel from a released position to a fully depressed position and indeterminate positions therebetween. The accelerator pedal 45 includes an associated sensor (not shown) that senses the position of the pedal 45. The sensor is configured to output a pedal-position signal to the controller 40 that is indicative of a sensed position of the pedal 45. The accelerator pedal 45 is used by the driver to command a desired speed of the vehicle. Under normal conditions, the accelerator pedal 45 is used by the driver to set a driver-demanded torque. The controller 40 may be programmed to receive the pedal-position signal and determine the driver-demanded torque based on pedal position and other factors.

The vehicle 20 may include one or more sensors 48 configured to determine accelerations of the vehicle. For example, the sensors 48 may include a yaw-rate sensor, a lateral-acceleration sensor, and a longitudinal-acceleration sensor. Used herein, “acceleration” refers to both positive acceleration (propulsion) and negative acceleration (braking). The yaw-rate sensor generates a yaw-rate signal corresponding to the yaw rate of the vehicle. Using the yaw-rate sensor, the yaw acceleration may also be determined. The lateral-acceleration sensor outputs a lateral-acceleration signal corresponding to the lateral acceleration of the vehicle. The longitudinal-acceleration sensor generates a longitudinal-acceleration signal corresponding to the longitudinal acceleration of the vehicle. The various sensors are in communication with the controller 40. In some embodiments, the yaw rate, lateral acceleration, longitudinal acceleration, and other measurements may be measured by a single sensor.

The vehicle 20 may also include a steering system 49 that turns the front wheels 30, 31. The steering system 49 may include a steering column 53 having a steering wheel 51 connected to a steering shaft that actuates a steering box, such as a rack-and-pinion assembly. The steering box is operably coupled to the front wheels 30, 32 and turns the wheels according to inputs from the steering wheel 51. The steering system 49 may include one or more sensors configured to output a signal indicative of steering angle to the controller 40. The steering sensor may measure rotation of the steering shaft or movement of another component(s).

The vehicle may be a pickup truck, SUV, cross-over, a dune-buggy, a recreational vehicle (RV), an all-terrain-vehicle (ATV), or any other vehicle capable of off-road use. The vehicle 20 may be driven forward by commanding a forward (also known as positive) torque to one or more of the electric machines 26 and 34. Similarly, the vehicle 20 may be driven in reverse by commanding a reverse (also known as positive) torque to one or more of the electric machines 26 and 34. That is, a forward torque command is a command to spin the electric machine in a direction that results in the wheels propelling the vehicle forward, and a reverse torque command is a command to spin the electric machine in a direction that results in the wheels propelling the vehicle backwards (commonly referred to as reverse.)

The vehicle may be capable of performing various off-road and limit-use maneuvers that are useful during trail driving or other off-road use. It is sometimes necessary to make tight turns during off-road driving. These turns may be tighter than the turning radius of the vehicle. In order to navigate these turns, the vehicle may include a pivot-assist mode (one type of off-road driving mode—the vehicle may include others) in which the vehicle pivots about the front axle or the rear axle. In some embodiments, the pivot-assist mode allows the driver to choose between a front pivot assist and a rear pivot assist. In other embodiments, the vehicle may only offer pivoting about the front axle or the rear axle. During the front pivot assist, the powertrain, steering system, and brakes of the vehicle are controlled such that the vehicle pivots about a front portion of the vehicle, e.g., about the front inside wheel. During the rear pivot assist, the powertrain steering system and brakes of the vehicle are controlled such that the vehicle pivots about a rear portion of the vehicle e.g., a center of the rear axle.

The pivot assist mode may be a user-selectable off-road mode that is enabled through a human-machine interface 64 disposed within a cabin of the vehicle 20. For example, the vehicle infotainment system, e.g., a touch-screen display, may include capacitive touch icon(s) that is used by the driver to select pivot-assist mode. Alternatively, a physical button may be used to enable/disable the pivot-assist mode. The physical button may be a switch, toggle, or the like and may be provided on the console, dashboard, steering wheel, gear shifter, or any other location within reach of the driver.

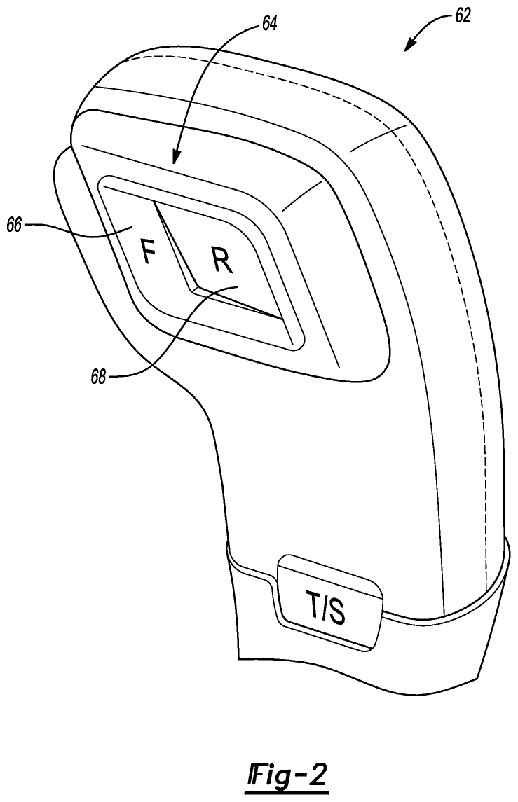

FIG. 2 illustrates one example embodiment of the input for activating a front or rear pivot-assist turn. Here, the input 64 is provided on the gear shifter 62 of the transmission. The input 64 includes one or more buttons such as a front button 66 and a rear button 68. The pressing of the front button 66 may be referred to as a front state of the input 64 and the pressing of the rear button 68 may be referred to as a rear state of the input 64. Pressing the front button 66 results in activation of the front pivot assist and pressing the rear button 68 results in activation of the rear pivot assist. In some embodiments, the input 64 may be a rocker switch with a resting OFF position, a forward position (front pivot assist) and a rear position (rear pivot assist). The vehicle may require the driver to hold the button 66/68 down throughout the duration of the pivot assist. That is, the pivot assist exits responsive to the button being released. In one example, the vehicle requires two layers of selection in order to activate the pivot assist. That is, the driver must first enable the pivot-assist driving mode, such as through the HMI 64. This places the vehicle in a ready position. A further driver input is then required to actually activate the mode i.e., the driver presses the front button 66 or the rear button 68. In other embodiments, the initial step of selecting the driving mode may not be required and the driver is only require depressed the front button 66 or the rear button 68 in order to activate the pivot-assist mode. Activation of the pivot assist may further require that the steering will be turned by a sufficient amount. That is, a measured angle of the steering system 49 exceeds a threshold, such 20°, 30°, 40°, or any other value a designer considers appropriate. The pivot assist may be unavailable when certain driving conditions are present. For example, pivot assist may not be available when the vehicle speed exceeds a threshold. The speed threshold may be based on a coefficient of friction of the driving surface, e.g., different speed thresholds for dirt versus snow. The speed threshold and/or steering angle threshold may be different for the front pivot assist verses the rear pivot assist.

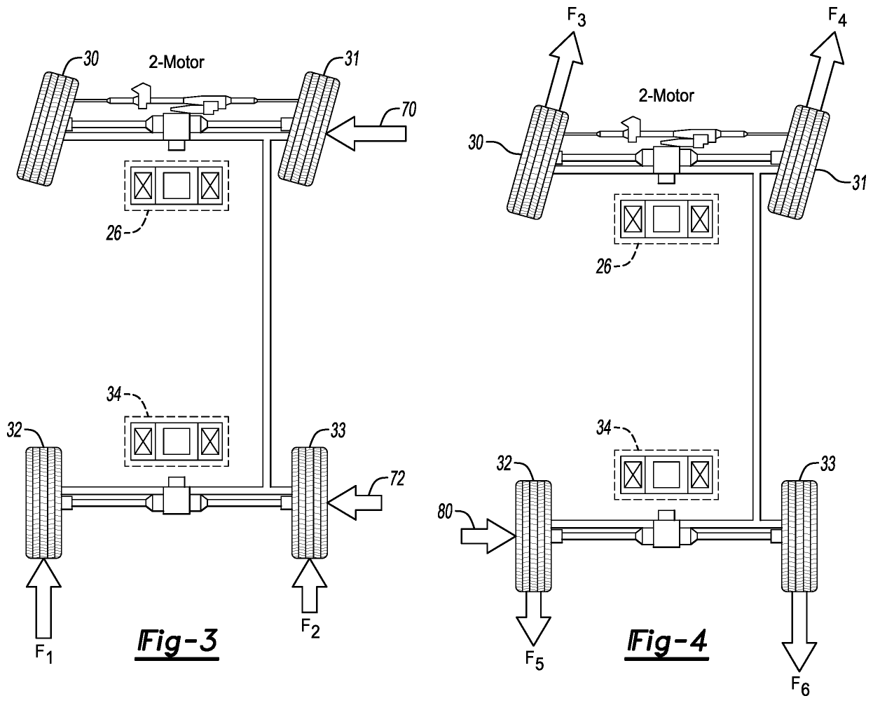

FIG. 3 schematically illustrates the vehicle 20 in a front pivot assist turn to the right. Here, the powertrain and brakes are controlled to create a pivot point near or at the front inside wheel (the front right wheel 31). The controller may be programmed to in response to (i) the vehicle being in an off-road driving mode, (ii) the input being in the first position, and (iii) the steering wheel being turned right beyond a threshold, command the shown brake and motor torques. For example, the controller commands braking torques 70 and 72 to the front and rear right wheels (via the friction brakes 42), respectively, commands zero torque to the first powerplant 26, and command a forward torque to the second powerplant 34 based on at least the driver-demanded torque. In this embodiment, the rear wheels 32, 33 are both coupled to the powerplant 34 by an open differential and receive equal torque therefrom. The braking torque 72 creates a force differential between rear wheels with the left wheel 32 having a larger force (F₁) than the force (F₂) at the right wheel 33. The friction brake on the front left wheel is not engaged. This combination of powertrain torques and braking torques creates a moment or pivot about or near the wheel 31.

The torque applied to the rear wheels 32 and 33 creates slip between the wheels and the ground thus facilitating the moment about the pivot point near or at wheel 31. During this mode, the torque commands provided to the powerplant 34 are based on a slip of the rear wheels and the driver-demanded torque. The controller may target a minimum slip at the rear wheels using closed-loop controls and may also set a maximum slip regardless of the accelerator pedal position. Thus, the driver can utilize the accelerator pedal to modulate the slip at the rear wheels between these minimum and maximum slip limits.

The magnitude of the braking torque 70 is a magnitude sufficient to create slip at the front inside wheel. The target slip may be based on the coefficient of friction of the ground surface. The controller may utilize close-loop feedback controls, e.g., a PI controller. The closed-loop feedback controls may compare a measured wheel speed to a target wheel speed and increase or decrease the torque 70 in order to reduce the error between the measured value and the target value.

The controller may use the following equations to determine values for the various powertrain and braking torques shown in FIG. 3.

$$rear powerplant torque = rear left wheel torque + rear right wheel torque \qquad ( Eq . 1 )$$

$$rear left wheel torque = rear right wheel torque + braking torque at rear right wheel \qquad ( Eq . 2 )$$

$${F}_{1} = ( rear right wheel torque + braking torque at rear right wheel ) \times tire radius \qquad ( Eq . 3 )$$

$${F}_{2} = F 2 = rear left torque \times tire radius \qquad ( Eq . 4 )$$

$$rear axle moment = ( {F}_{1} - {F}_{2} ) \times rear track \qquad ( Eq . 5 )$$

FIG. 4 schematically illustrates the vehicle 20 in a rear pivot assist turn to the right. Here, the powertrain and brakes are controlled to create a pivot point near or at the center of the rear axle. Here, the controller may be programmed to, in response to (i) the vehicle being in the off-road driving mode, (ii) the input being in the second position (e.g., button 68 is depressed), and (iii) the steering wheel being turned right beyond the threshold: command a braking torque 80 to the left rear wheel 32, command a forward torque to the powerplant 26 based on at least the driver-demanded torque, and command a reverse torque to the second powerplant 34. The torques are commanded to the front and rear powerplants 26, 34 such that the left side of the vehicle has a forward force and the right side of the vehicle has a reverse force causing the vehicle to pivot point at or near the center of the rear axle. That is, the front left wheel 30 has a forward force F₃ and the front right wheel 31 has a forward force F₄, and the rear wheels have reverse forces F₅ and F₆, respectively. The force F₆ is larger than the force F₅ due to the braking torque 80 applied at by the friction brake associated with the wheel 32.

The controller may use the following equations to determine values for the various powertrain and braking torques shown in FIG. 4:

$$rear powerplant torque = rear left wheel torque + rear right wheel torque \qquad ( Eq . 6 )$$

$$rear right wheel torque = rear left wheel torque + braking torque at rear left wheel \qquad ( Eq . 7 )$$

$${F}_{5} = ( rear right wheel torque - braking torque at rear left wheel ) \times tire radius \qquad ( Eq . 8 )$$

$${F}_{6} = ( rear right wheel torque ) \times tire radius \qquad ( Eq . 9 )$$

$$rear axle moment = ( {F}_{5} - {F}_{6} ) \times rear track \qquad ( Eq . 10 )$$

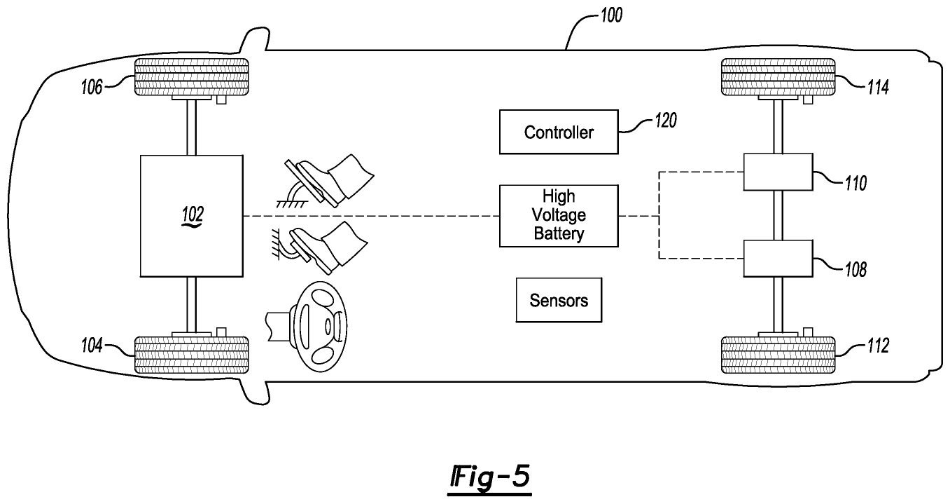

FIG. 5 illustrates another vehicle 100 that is similar to the vehicle 20 but includes a pair of motors on the rear axle, each dedicated to one of the rear wheels. The vehicle 100 has many aspects that are the same as the vehicle 20 and, for brevity, these aspects will not be discussed again. (Please see the description of the vehicle 20.) The vehicle 100 may include a single powerplant 102, e.g., an electric machine or internal combustion engine, that drives the front wheels 104 and 106. At the rear axle, a pair of electric motors 108 and 110 are provided. The motor 108 drives the wheel 112 and the motor 110 drives the wheel 114. Each of the wheels may include a friction brake as discussed above.

The vehicle 100 includes a controller 120 programmed to operate the vehicle 100 in one or more off-road modes such as the pivot assist modes as discussed above. The inclusion of two electric machines on the rear axle modifies the control commands of the controller 120 for performing the front pivot assist and the rear pivot assist, which will now be described in detail.

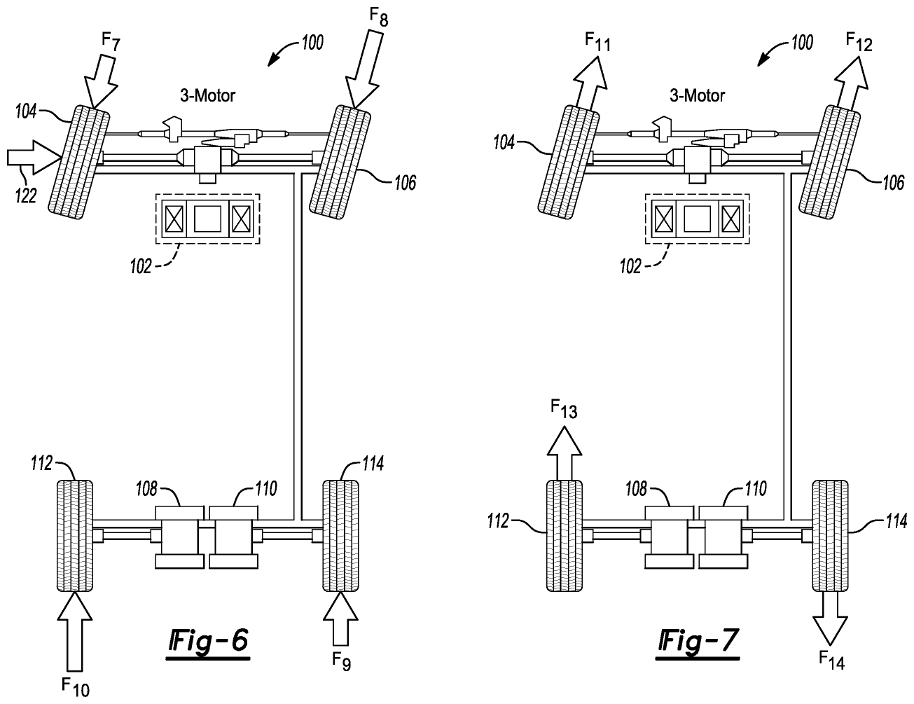

FIG. 6 schematically illustrates the vehicle 100 in a front pivot assist turn to the right. The maneuver is similar to that of FIG. 3, expect the changes in powertrain hardware modify at least some of the controls. For example, the use of dual-rear electric machines eliminates the need for braking the inside rear wheel. Instead, the motor torques for each wheel are individually controlled so the force of the outside wheel 112 is greater than the inside wheel 114.

The controller may be programmed to, in response to (i) the vehicle being in an off-road driving mode, (ii) the input being in the first position, and (iii) the steering wheel being turned right beyond a threshold: command a braking torque 122 to the left front wheel 104, command a reverse torque to the first powerplant 102, command a first forward torque to electric machine 108, and command a second forward torque to electric machine 110 that is less than the first forward torque.

The front powerplant 102 may deliver equal torque to the front wheels 104 and 106 through an open differential of the front axle. The braking torque 122 applied to the outside front wheel 104 creates a differential force between the front wheels. That is, the reverse force F₇ is less than the reverse force F₈. The force differentials of the rear axle do not require application of the brakes due to the dual-motor architecture. The controller 120 commands less torque from the electric machine 110 then the electric machine 108 to create a force differential between the forces F₉ and F₁₀. The force F₁₀ is greater than the force F₉, and the force F₇ is less than the force F₈ to create a moment about (or near) the front inside wheel 126 to facilitate sharper cornering when off-roading.

The controller may use the following equations to determine values for the various powertrain and braking torques shown in FIG. 6.

$$front powerplant torque = front left wheel torque + front right wheel torque \qquad ( Eq . 11 )$$

$$front right wheel torque = front left wheel torque + braking torque at front left wheel \qquad ( Eq . 12 )$$

$${F}_{10} = rear left wheel torque \times tire radius \qquad ( Eq . 13 )$$

$${F}_{9} = rear right wheel torque \times tire radius \qquad ( Eq . 14 )$$

$$rear axle moment = ( {F}_{9} - {F}_{10} ) \times rear track \qquad ( Eq . 15 )$$

FIG. 7 schematically illustrates the vehicle 100 in a rear pivot assist turn to the right. The maneuver is similar to that of FIG. 4, expect the changes in powertrain hardware modifies at least some of the controls. For example, the use of dual-rear electric machines eliminates the need for braking the outside rear wheel. Instead, the motor torques for each wheel are individually controlled so that both the magnitude and the directions of torques at the rear wheels 112, 114 are different. The controller 120 may be programmed to, in response to (i) the vehicle being in the off-road driving mode, (ii) the input being in the rear position, and (iii) the steering wheel being turned right beyond the threshold: command a positive torque to the first powerplant 102, command a forward torque to the electric machine 108, and command a reverse torque to the electric machine 110. The magnitude of the torque of motor 108 may be greater than the magnitude of the torque of motor 110. The torques applied to the front wheels 104 and 106 may be the same. This results in the front wheels have forward forces F₁₁ and F₁₂, the wheel 112 having forward force F₁₃, and the wheel 114 having a reverse force F₁₄. This creates a moment about a center (or near the center) of the rear axle.

The controller may use the following equations to determine values for the various powertrain and braking torques shown in FIG. 7.

$${F}_{11} = front left wheel torque \times tire radius \qquad ( Eq . 16 )$$

$${F}_{12} = front right wheel torque \times tire radius \qquad ( Eq . 17 )$$

$${F}_{13} = rear left wheel torque \times tire radius \qquad ( Eq . 18 )$$

$${F}_{14} = rear right wheel torque \times tire radius \qquad ( Eq . 19 )$$

$$rear axle moment = ( {F}_{13} + {F}_{14} ) \times rear track \qquad ( Eq . 20 )$$

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to strength, durability, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A vehicle comprising:
a front axle including left and right front wheels and operably coupled to a first powerplant;
a rear axle including left and right rear wheels operably coupled to a second powerplant;
a steering wheel;
at least one driver-actuatable input including at least a first state and a second state; and
a controller programmed to, in response to (i) the vehicle being in an off-road driving mode, (ii) the input being in the first position, and (iii) the steering wheel being turned right beyond a threshold:
command braking torques to the front and rear right wheels, respectively,
command zero torque to the first powerplant, and
command a forward torque to the second powerplant based on a driver-demanded torque.

2. The vehicle of claim 1, wherein the braking torque commanded to the front right wheel is greater than the braking commanded to the rear right wheel.

3. The vehicle of claim 1, wherein the driving mode is a pivot-assist mode, and the first state of the input corresponds to a front pivot assist and second state of the input corresponds to a rear pivot assist.

4. The vehicle of claim 1, wherein the first and second powerplants are electric machines.

5. The vehicle of claim 1, wherein the controller is further programmed to, in response to (i) the vehicle being in the off-road driving mode, (ii) the input being in the second state, and (iii) the steering wheel being turned right beyond the threshold:
command a braking torque to the left rear wheel,
command a forward torque to the first powerplant based on the driver-demanded torque, and
command a reverse torque to the second powerplant.

6. The vehicle of claim 5, wherein the reverse torque commanded to the second powerplant is independent of the driver-demanded torque.

7. The vehicle of claim 6, wherein the reverse torque commanded to the second powerplant is based on a target slip of the right rear wheel.

8. The vehicle of claim 6, wherein the forward and reverse torques are commanded such that a sum of torques of the front axle and the rear axle is ZERO.

9. The vehicle of claim 5, wherein the braking torque commanded to the left rear wheel is a based on an angle of the steering wheel.

10. A vehicle comprising:
a front axle including left and right front wheels and operably coupled to a first powerplant;
a rear axle including left and right rear wheels operably coupled to first and second electric machines, respectively;
a steering wheel;
a controller programmed to in response to (i) a front pivot assist being requested and (ii) the steering wheel being turned right beyond a threshold:
command a braking torque to the left front wheel,
command a reverse torque to the first powerplant,
command a first forward torque to first electric machine, and
command a second forward torque to the second electric machine that is less than the first forward torque.

11. The vehicle of claim 10 further comprising an input operable to request the front pivot assist.

12. The vehicle of claim 10, wherein the controller is further programmed to, in response to (i) a rear pivot assist being requested and (ii) the steering wheel being turned right beyond the threshold:
command a forward torque to the first powerplant,
command a forward torque to the first electric machine, and
command a reverse torque to the second electric machine.

13. The vehicle of claim 12, wherein a magnitude of the positive torque to the first electric machine is greater than a magnitude of the negative torque to the second electric machine.

14. A vehicle comprising:
a front axle including left and right front wheels and operably coupled to a powerplant;
a rear axle including left and right rear wheels operably coupled to first and second electric machines, respectively;
a steering wheel;
an accelerator pedal;
at least one driver-actuatable input; and
a controller programmed to:
in response to the accelerator pedal being depressed, the steering wheel being turned RIGHT, and the at least one driver-actuatable input being selected, command forward torques to the powerplant and the first electric machine and command a reverse torque to the second electric machine, and
in response to the accelerator pedal being depressed, the steering wheel being turned LEFT, and the at least one driver-actuatable input being selected, command forward torques to the powerplant and the second electric machine and command a reverse torque to the first electric machine.

15. The vehicle of claim 14, wherein the reverse torque commanded to the second electric machine has a magnitude that is greater than a magnitude of the forward torque commanded to the first electric machine.

16. The vehicle of claim 15, wherein the magnitude of the reverse torque is greater than a magnitude of the propulsion torque commanded to the powerplant.

17. The vehicle of claim 14, wherein the powerplant is an electric machine.

18. The vehicle of claim 14, wherein the reverse torque commanded to the second electric machine has a magnitude that is based on an angle of the steering wheel.

19. The vehicle of claim 14 further comprising friction brakes each associated with one of the wheels, wherein the controller is further programmed to engage the friction brake associated with the left front wheel responsive to the accelerator pedal being depressed, the steering wheel being turned RIGHT, and the at least one driver-actuatable input being selected.

20. The vehicle of claim 19, wherein the reverse torque commanded to the second electric machine has a magnitude that is based on an angle of the steering wheel, and engagement of the friction brake associated with the left front wheel is based on the angle of the steering wheel.
